(19) United States
(12) Patent Application Publication
(10) Pub. No.: US 2013/0172662 A1
(43) Pub. Date: Jul. 4, 2013

(54) PARTIALLY IMPLANTABLE HEARING ASSISTANCE SYSTEM

(71) Applicants: Stefan Menzl, Jona (CH); Herbert Bächler, Zurich (CH)

(72) Inventors: Stefan Menzl, Jona (CH); Herbert Bächler, Zurich (CH)

(73) Assignee: ADVANCED BIONICS AG, Zug (CH)

(21) Appl. No.: 13/698,770

(22) PCT Filed: May 17, 2010
(86) PCT No.: PCT/EP10/56748

§ 371 Date: Mar. 12, 2013

(51) Int. Cl. H04R 25/00

(52) U.S. Cl. CPC H04R 25/00
USPC 600/25

(57) ABSTRACT

A partially implantable hearing assistance system, having: an external unit (10) to be worn at least in part in a user's ear canal (12), a device (14) for capturing audio signals from ambient sound, an audio signal processing unit (16, 18) for generating first intermediate signals from said audio signals, and at least one electroacoustic output transducer (20, 20A) in order to make the user's eardrum (46) vibrate according to the first intermediate signals; and an implantable unit (22, 122) having an input transducer (42) located in the user's middle ear for capturing second intermediate signals from the vibration of the eardrum (46), an actuator (26, 60) for stimulating the user's hearing, and a driver unit (48, 148) for transforming the second intermediate signals into an input signal to the actuator (26, 60).

### BACKGROUND OF THE INVENTION

1. Field of the Invention

The invention relates to a partially implantable hearing assistance system comprising means for capturing audio signals from ambient sound, means for processing audio signals and an implantable actuator for stimulating the user's hearing according to processed audio signals.

2. Description of Related Art

A partially implantable hearing aid typically comprises an external unit to be worn at the head close to the ear, which usually comprises a microphone for capturing ambient sound, a power source (battery), an audio signal processing unit and a transmitter, and an implantable unit comprising a receiver and the actuator, which may be a middle ear implant, such as an electro-mechanical transducer, or a cochlear implant (i.e., a simulation electrode). Usually, the audio signals/audio data and power are transmitted via an inductive coupling RF (radio frequency) link from the transmitter to the receiver. An example of such a partially implantable cochlear stimulation system is found in U.S. Patent Application Publication 2007/0260292 A1, while U.S. Pat. No. 6,005,955 relates to a partially implantable hearing aid comprising an implantable output transducer which is a piezo-electrical transducer mechanically coupled to an ossicle after opening of the ossicular chain.

U.S. Pat. No. 5,456,654 relates to an implantable electro-magnetic transducer for a hearing aid, wherein a magnet fixed to the eardrum generates an alternating magnetic field which is captured by an implanted coil.

It is difficult to transmit both audio data and power via a RF link, since efficient transmission of power requires a high-quality factor of the antenna, whereas, by contrast, a sufficiently high data transmission rate of audio signals requires a large bandwidth. Typically, commercially available hearing aids have an RF link which realizes a compromise between these two requirements, resulting in high power consumption which, in turn, results to large, unattractive form factors (usually two or three batteries of the size 675 are necessary). As a consequence, small children hardly can wear BTE (Behind-the-Ear)-type devices and their ears may get deformed by the weight of the device. The use of two different RF frequencies is not very attractive, since the two antennas required then have a negative impact on complexity and size of the device. Transmission frequencies in the GHz range would result in small antennas; however, adsorption by the human body is too high at such high frequencies.

Percutaneous power transmission is considered to be necessary, since the capacities of implantable batteries are relatively low and the number of charge cycles limited.

International Patent Application Publication WO 2009/047370 A2 relates to a partially implantable hearing aid, wherein the audio signals/audio data are transmitted from the external unit to the implantable output transducer via an optical link through the eardrum, while power is transmitted via an inductive link.

French Patent FR 1.113.759 relates to a hearing aid, wherein audio signals captured from ambient sound are transmitted via bone conduction as ultrasound signals to an ultrasound receiver located in the mouth of the user at the teeth.

U.S. Patent Application Publication 2007/0270675 A1 relates to an implantable medical device comprising a percutaneous acoustic link from a pulse generator to an implanted chemical sensor. U.S. Patent Application Publication 2005/0261741 A1 relates to a device for ventricular resynchronization pacing therapy including an acoustic link to an implanted pacemaker.

U.S. Patent Application Publication 2004/0200281 A1 relates to a MEMS accelerometer sensor for a middle ear implant.

### SUMMARY OF THE INVENTION

It is an object of the invention to provide for a partially implantable hearing aid, which avoids the need for bulky external parts of the system. It is a further object to provide for a corresponding hearing assistance method.

According to the invention, these objects are achieved by a partially implantable hearing assistance system and a method as described herein.

The invention is beneficial in that, by transmitting the audio signals/audio data via an acoustic link using the eardrum to the implantable unit, the power consumption of the system can be reduced, since the power link can be separated from the data link and hence can be optimized. Due to reduced power consumption of the system, the size of the external unit can be reduced. In addition, the size of the externally visible part of the system can be minimized due to the design of the external unit which is to be worn at least in part in the user's ear canal. Preferably, the external unit is designed as a CIC (completely-in-the-canal), ITC (in-the-canal), ITE (in-the-ear) or mini-BTE with ex-receiver.

Typically, the audio signals/audio data will be transmitted via the acoustic link in a manner that they are not perceivable by the patient. This can be achieved by selecting the frequencies and levels of the acoustically transmitted intermediate signals according to the individual hearing loss of the user. In this regard, the present invention is particularly useful for patients suffering from profound hearing loss, for example, patients having a need for a cochlear implant (CI) or a device for direct mechanical stimulation of the cochlea, since in this case there is sufficient “free” bandwidth in the higher audio frequency range for acoustic transmission.

Preferably, the input transducer acting as the receiver of the acoustic link is an accelerometer fixed at an ossicle. Thereby, the natural impedance transformation of the middle ear (from air to bone) acts on the input transducer (a microphone located in the middle ear would not “see” this impedance transformation; in particular, a microphone located in the middle ear would have low sensitivity in the high audio frequency range due to the very strong decay of the transfer function from the free sound field to the middle ear at high frequencies (second order low pass)).

Preferably, the audio signals are compressed prior to transmission by reducing audio signal components which would not result in perceivable stimulation of the patient's hearing by the implantable actuator. For example, if the actuator is a cochlear implant, only those frequency bands of the audio signal would be transmitted which play a role in the stimulation by the cochlear electrode, namely the maxima of the envelope function in the time domain and in the frequency domain.

Further, the audio signals preferably are “pre-distorted” prior to transmission via the acoustic link in order to adapt the payload and the available transmission bandwidth. The available frequency range and the available volume range are limited not only by the technical parameters (available transmission power, available receiver sensitivity, channel properties, etc.), but in particular also by the hearing loss of the patient.

Multi-frequency modulation may be used for acoustic link, wherein within the available bandwidth a plurality of frequency bands is defined and for each frequency band the available volume range is calculated according to the individual hearing loss. The lower limit is given by the weakest acoustic intermediate signal which can be detected by the input transducer, and the upper limit is given by the strongest acoustic signal which still is not perceivable by the patient. It may also be required, to transpose information from one frequency band to another to achieve the required overall performance.

The acoustic link may be used for digital signal transmission or for analog signal transmission.

These and further objects, features and advantages of the present invention will become apparent from the following description when taken in connection with the accompanying drawings which, for purposes of illustration only, show several embodiments in accordance with the present invention.

### BRIEF DESCRIPTION OF THE DRAWINGS

FIG. 1 is a schematic view of an example of a partially implantable hearing aid according to the invention comprising an electro-mechanical actuator;

FIG. 2 is a view like FIG. 1, but showing an example of a partially implantable hearing aid according to the invention comprising a cochlear implant; and

FIG. 3 is a schematic illustration of available bandwidth and volume range together with the individual hearing loss of the patient.

### DETAILED DESCRIPTION OF THE INVENTION

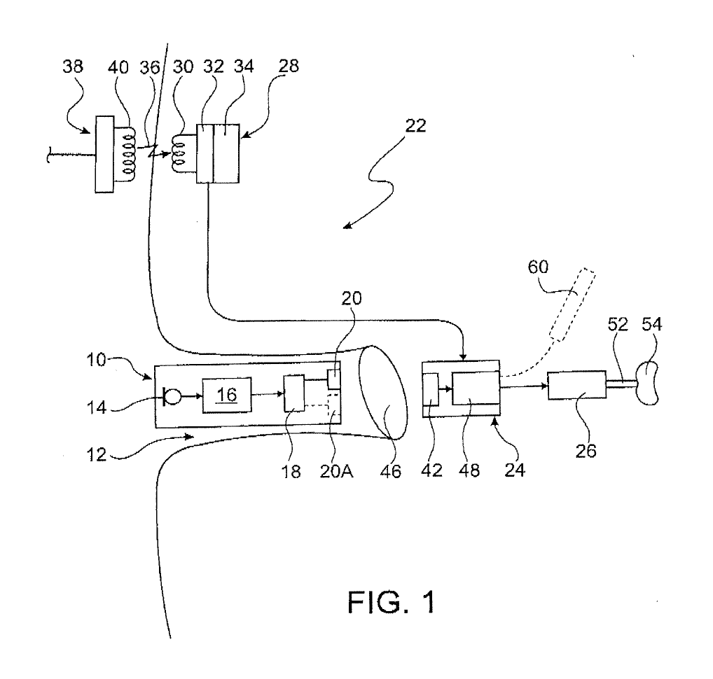

FIG. 1 shows a system that comprises an external unit 10, which is designed as a modified CIC hearing aid and which is to be worn in the user's ear canal 12. The external unit 10 comprises a microphone arrangement 14, an audio signal processing unit 16, a power amplifier 18 and an electroacoustic output transducer (loudspeaker) 20. The microphone arrangement 14 may comprise at least two spaced-apart microphones (not shown) in order to provide an acoustic beam-forming capability. The audio signal processing unit 16 processes the audio signals provided by the microphone arrangement 14 and supplies the processed audio signals as first intermediate signals to the amplifier 18 which drive the speaker 20. The external unit 10 also comprises a battery (not shown) which may be rechargeable. The audio signal processing unit 16 may be implemented by an ultra-low power hearing instrument DSP (Digital Signal Processor). Thus, the external unit 10, apart from the type of audio signal processing (which will be explained below), essentially corresponds to a CIC hearing aid.

The system also includes an implantable unit 22 comprising an implanted audio signal unit 24, an electro-mechanical actuator 26 and a power management unit 28.

The power management unit 28 comprises a power receiving coil 30, a power management circuitry 32 and a rechargeable battery 34. The battery 34 is charged via percutaneous inductive power link 36 by an external charging adapter 38 comprising a power transmission coil 40 which transmits power to the power receiving coil 30 of the power management unit 28. The rechargeable battery 34 should be dimensioned for lasting at least a full day and it should be possible to recharge it within a few hours; charging must be feasible during normal operation of the hearing aid or at night. Preferably, the rechargeable battery 34 is designed in thin-film lithium technology or conventional Lithium ion technology. The power management unit 28 serves as a power supply for the implantable audio signal unit 24 and the actuator 26.

The implantable audio signal unit 24 comprises an input transducer 42 located in the middle ear cavity as a receiver for the acoustic signals emitted by the speaker 20, which acoustic signals make the eardrum 46 and the ossicular chain (not shown) vibrate. The implantable audio signal unit 24 also comprises a decoder/driver unit 48 which serves to drive the actuator 26. The input transducer 42 serves to capture second intermediate signals from the vibration of the eardrum (and the resulting vibration of the ossicular chain), and the decoder/driver unit 48 serves to transform the second intermediate signals into an input signal to the actuator 26.

The speaker 20 and the input transducer 42 serve to realize an acoustic link for transmitting audio signals and/or audio data signals from the external unit 10 to the implantable unit 22.

Not only the input transducer 42, but also the other components of the entire unit 24 may be located in the middle ear cavity.

In the embodiment of FIG. 1, the actuator 26 is an electromechanical (electro-magnetical or piezo-electric) transducer which is coupled via a coupling element 52 to a middle ear component 54, namely an ossicle or the cochlear wall. The actuator 26 may be designed, for example, as a floating mass transducer (FMT) fixed at one of the ossicles or as a direct acoustic cochlear stimulator (DACS) directly acting on the cochlear wall, i.e., footplate, oval window, round window or any artificial opening of the cochlear. In some of the cases, there would be a need to interrupt the ossicular chain mechanically or decouple the dynamic range still in use.

Alternatively, the actuator may be a cochlear electrode 60 (indicated in dashed lines in FIG. 1) which replaces the electromechanical actuator.

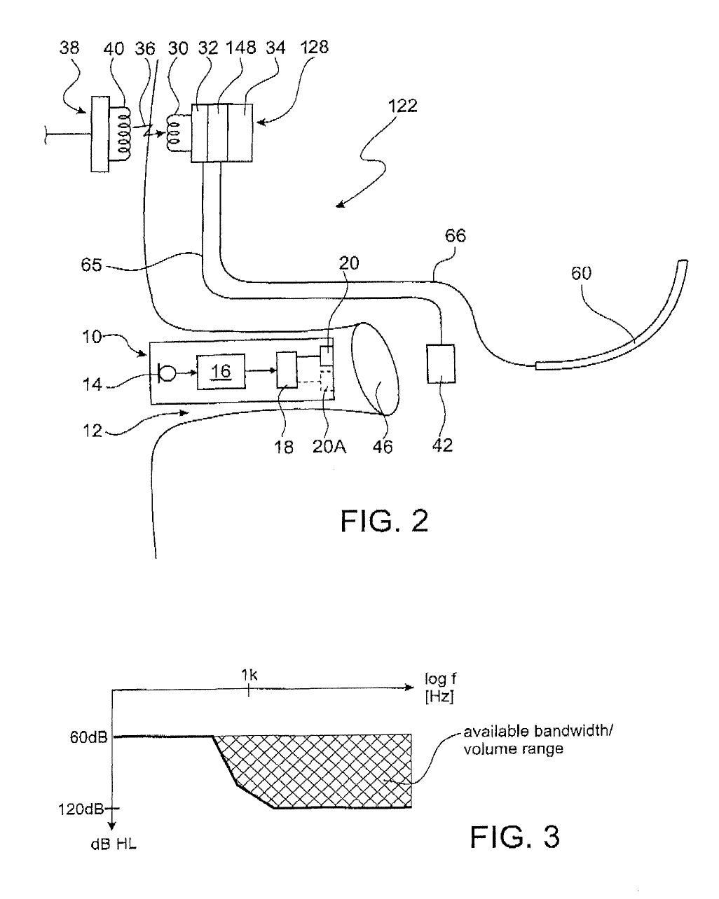

An alternative embodiment of an implantable unit 122 is shown in FIG. 2, wherein only the input transducer 42 is located in the middle ear cavity, while the decoder function and the driver function are integrated within the power management unit 128 as a decoder/driver unit 148 which supplies electrical stimulation signals to a cochlear electrode 60 via a wire 66. The input transducer 42 is connected to the decoder/driver unit 148 via a wire 65.

Usually, the power management unit 28, 128 is located within an artificial cavity created in the mastoid region or directly on the bone behind the ear.

According to modified embodiments of FIGS. 1 and 2, the external unit 10 may be designed as a modified BTE hearing aid (BTE hearing aid with ex-receiver), wherein the speaker 20 is located in the ear canal 12 and is connected by wire to the part worn behind the ear. Alternatively, the external unit 10 may have the design of an ITC or ITE hearing aid.

Usually, the input transducer 42 is mechanically coupled to the eardrum or the ossicular chain. Preferably, the input transducer 42 is an accelerometer attached to the ossicular chain. Such embodiment is beneficial in that then the natural impedance transformation caused by the middle ear from air to bone acts on the transducer 42. Alternatively, the input transducer 42 may be a piezo-transducer attached to the ossicular chain after cutting the ossicular chain (an example of such a transducer is found in U.S. Pat. No. 6,005,955) or a magnet which is attached to the ear drum 46 and cooperates with an implanted coil (an example of such a transducer is found in U.S. Pat. No. 5,456,654). An artificial malleus may be used for transmitting the vibrations of the eardrum 46.

The acoustic link of the present invention preferably is used for transmitting audio data signals from the external unit 10 to the implantable unit 22, 122, i.e., the first intermediate signals are first audio data signals, and the second intermediate signals are second audio data signals, with the second audio data signals, apart from transmission losses, corresponding to the first audio data signals. The audio data signals may be digital or analog. In the case of digital signals, a multi-frequency modulation method may be used for parallel multi-channel transmission in order to achieve a sufficiently high bit transmission rate. Also in the case of analog data transmission, the first audio data signals may be divided into a plurality of frequency bands, wherein each frequency band corresponds to a certain frequency range of the audio signals and each frequency band is for feeding a separate channel of the actuator, wherein the level of each frequency band corresponds to the stimulation amplitude of the respective channel as caused by the actuator. In case of a cochlear electrode as the actuator, each channel corresponds to a different stimulation site within the cochlea.

By pre-distorting the audio signals prior to transmission via the acoustic link, the payload and the available transmission bandwidth are adjusted. In particular, the available frequency range and the available dynamic range are limited not only by the technical circumstances, but also by the individual hearing loss. In the case of analog data transmission, the level of each of the frequency bands of the first audio data signals is limited according to the hearing loss of the user in such manner that the respective stimulation of the ear drum by the speaker 20 in the respective frequency range will not be perceived by the user. The minimum level of each of the frequency bands is adjusted in such a manner that the signal in the respective frequency band still can be captured by the input transducer 42.

Also for digital signal transmission the first audio data signals may be generated by selecting frequencies and levels in a manner that the vibration of the user's ear drum caused by the speaker 20 is not perceivable by the user, wherein the levels and frequencies preferably are controlled according to the individual hearing loss of the user.

In general, prior to the pre-distortion of the signals, the audio signals may be compressed in order to reduce the data which need to be transmitted. Such compression is achieved by removing audio signal components which will not result in perceivable stimulation of the user's hearing by the actuator 26. To this end, the audio signals may be divided into a plurality of frequency bands and those bands will be removed which will not result in perceivable stimulation of the user's hearing by the actuator 26.

An example of the band-width and volume range available for data transmission via the acoustic link is shown in FIG. 3 for a typical individual hearing loss at high audio frequencies.

In order to avoid—in case that the external unit 10 does not have a specifically attributed shape—the inadvertent use of a hearing aid which is not associated with the specific implantable unit 22, 122 as the external unit 10, the acoustic link may be provided with a specific code which allows the implantable unit 22, 122 to identify the respective external unit 10. To this end, the external unit 10 may be adapted to change the modulation frequencies in a cyclic manner or in a random manner. In this case, the first audio data signals are generated in a manner that redundant data, such as a check sum, is included in the first audio data signal. The implantable unit 22, 122 may be designed such that it works only if it has recognized the correct external unit 10.

According to a modification of the embodiments described so far, the system may be designed as a bi-modal instrument, wherein a first portion of the audio signals is processed in a manner that the vibration of the user's ear drum 46 caused by the speaker 20 according to such processed first portion of the audio signals is perceivable by the user as sound, while only a second portion of the audio signals is used to generate the first audio data signals in the manner described above. In this case, the system works both as a conventional electroacoustic hearing aid and as a partially implantable hearing aid. Preferably, the low audio frequencies are used for conventional acoustic stimulation of the user's hearing, and the higher audio frequencies are used for stimulation via the implantable actuator 26. The reason is that usually the hearing loss is more pronounced at high frequencies. For such bi-modal embodiments, the single speaker 20 may be replaced by two speakers (as indicated by an additional speaker 20A drawn in dashed lines in FIGS. 1 and 2), wherein the first speaker 20A is used for the conventional acoustic stimulation and the second speaker 20 is used for the acoustic data link. In addition, two separate signal processors may be used for the conventional acoustic stimulation channel and the acoustic data link channel. It is mentioned that a conventional digital hearing aid is well suited for analog audio data transmission via the acoustic link, since a digital hearing aid as such is already a multi-channel compressor which can be easily adjusted to compress and pre-distort the audio signals in the manner described above with regard to multi-channel audio data transmission

It is also noted that the acoustic link of the present invention could be used not only for audio data, but also for “base band” signal transmission via the acoustic link; i.e., there is no modulation of the audio signals prior to transmission. In this case, the audio signals received by the input transducer 42 will undergo the necessary audio signal processing in the implantable audio signal unit 24 prior to being supplied as input to the actuator 26. While thereby the external unit 10 can be simplified, the signal processing in the implantable audio signal unit 24 usually will be more complex.

While various embodiments in accordance with the present invention have been shown and described, it is understood that the invention is not limited thereto, and is susceptible to numerous changes and modifications as known to those skilled in the art. Therefore, this invention is not limited to the details shown and described herein, and includes all such changes and modifications as encompassed by the scope of the appended claims.

1. A partially implantable hearing assistance system, comprising:
an external unit to be worn at least in part in a user's ear canal, comprising means for capturing audio signals from ambient sound, an audio signal processing unit for generating first intermediate signals from said audio signals, and at least one electroacoustic output transducer in order to make a user's eardrum vibrate according to the first intermediate signals; and
an implantable unit comprising an input transducer located in a user's middle ear for capturing second intermediate signals from a vibration of the eardrum, an actuator for stimulating a user's hearing, and a driver unit for transforming the second intermediate signals into an input signal to the actuator.

2. The system of claim 1, further comprising external means for transmitting power transcutaneously to the implantable unit via an inductive link, wherein the implantable unit comprises a power receiving means.

3. The system of claim 1, wherein the first intermediate signals are first audio data signals, and wherein said second intermediate signals are second audio data signals.

4. The system of claim 3, wherein the audio signal processing unit is adapted to compress, when generating the first audio data signals, the audio signals in a manner so as to remove audio signal components which will not result in perceivable stimulation of the user's hearing by the actuator.

5. The system of claim 4, wherein the audio signal processing unit is adapted to divide the audio signals into a plurality of frequency bands, and wherein those frequency bands which will not result in perceivable stimulation of the user's hearing by the actuator are removed from the audio signals in order to achieve said compression of the audio signals.

6. The system of claim 3, wherein the audio signal processing unit is adapted to generate the first audio data signals by selecting frequencies and levels of the first audio data signals in a manner that the vibration of the user's eardrum by the electroacoustic output transducer according to the first audio data signals is not perceivable by the user.

7. The system of claim 6, wherein the audio signal processing unit is adapted to control levels and frequencies of the first audio data signals according to the individual hearing loss of the user.

8. The system of claim 7, wherein the audio signal processing unit is adapted to divide the first audio data signals into a plurality of frequency bands.

9. The system of claim 8, wherein each frequency band corresponds to a certain frequency range of the audio signals and each frequency band is for feeding a separate channel of the actuator, wherein a level of each frequency band corresponds to the stimulation amplitude of a respective channel caused by the actuator.

10. The system of claim 9, wherein the audio signal processing unit is adapted to limit the level of each of the frequency bands of the first audio data signals according to the hearing loss of the user in that frequency band such that the respective stimulation of the eardrum by the electroacoustic output transducer in that frequency range will not be perceived by the user.

11. The system of claim 10, wherein the audio signal processing unit is adapted to provide a minimum level of each of the frequency bands of the first audio data signals in such a manner that it can be captured by the input transducer as part of the second audio data signals.

12. The system of claim 3, wherein the first audio data signals are digital signals.

13. The system of claim 12, wherein the audio signal processing unit is adapted to generate the first audio data signal according to a multi-frequency modulation method for parallel bit transmission.

14. The system of claim 3, wherein the audio signal processing unit is adapted to process a first portion of the audio signals in a manner that the vibration of the user's eardrum by the electroacoustic output transducer according to said processed first portion of the audio signals is perceivable by the user as sound and to generate the first audio data signals from a second portion of the audio signals in a manner that the stimulation of the user's eardrum by the electroacoustic output transducer according to the first audio data signals is not perceivable by the user.

15. The system of claim 14, wherein a first electroacoustic output transducer is provided for vibrating the user's eardrum according to the processed first portion of the audio signals and a second electroacoustic output transducer is provided for vibrating the user's eardrum according to the first audio data signals.

16. The system of claim 3, wherein the audio signal processing unit and the driver unit are associated to each other in a manner that the audio signal processing unit is adapted to generate the first audio data signals in an individual manner so that the driver unit is able to identify, by analyzing the second audio data signals, the respective audio signal processing unit.

17. The system of claim 16, wherein the audio signal processing unit is adapted to change the modulation frequencies of the first audio data signals in cyclic or random manner.

18. The system of claim 17, wherein the audio signal processing unit is adapted to generate the first audio data signals in a manner that redundant data, such as a check sum, is included in the first audio data signals.

19. The system of one of claim 1, wherein the first intermediate signals are processed first audio signals, and wherein the second intermediate signals are second audio signals.

20. The system of claim 19, wherein a first electroacoustic output transducer is provided for perceivable acoustic stimulation of the user's eardrum according to a processed first portion of the audio signals and a second electroacoustic output transducer is provided for acoustic stimulation of the user's eardrum according to a processed second portion of the audio signals, and wherein the driver unit is adapted to transform only second audio signals corresponding to said second portion of the audio signals into an input signal to the actuator, with said first portion of the audio signals serving to directly stimulate the user's hearing via the eardrum and said second portion of the audio signals serving to stimulate the user's hearing via the actuator.

21. The system of claim 9, wherein the actuator is a cochlear electrode and wherein each channel corresponds to a different stimulation site.

22. The system of claim 1, wherein the implantable output transducer is a cochlear electrode or an electromechanical transducer (26) for direct mechanical stimulation of the cochlea.

23. The system of claim 1, wherein the external unit is designed like a CIC, ITC, ITE or BTE hearing aid.

24. The system of claim 1, wherein the input transducer (42) is mechanically coupled to the eardrum (46) or an ossicular chain.

25. The system of claim 24, wherein the input transducer is an acclerometer attached to the ossicular chain, a piezo transducer attached to the ossicular chain, or a magnet which is attached to the eardrum and cooperates with a coil.

26. The system of claim 2, wherein the power transmitting means is a charging adapter (38) and the power receiving means comprises a rechargeable battery.

27. A method of providing hearing assistance to a user, comprising:
capturing audio signals from ambient sound;
generating first intermediate signals from said audio signals by an audio signal processing unit and supplying said first intermediate signals to an electroacoustic output transducer in order to make a user's eardrum vibrate according to the first intermediate signals;
capturing, by an input transducer located in a user's middle ear, second intermediate signals from the vibration of the eardrum;
transforming the second intermediate signals into an input signal to an implantable actuator for stimulating the user's hearing; and
stimulating the user's hearing according to said input signals.
